(19) United States
(12) Patent Application Publication
(10) Pub. No.: US 2021/0129403 A1
(43) Pub. Date: May 6, 2021

(54) High Lubricity Self-Cleaning Alignment Lock Assembly

(71) Applicant: Accura-Tec, Inc., Helenville, WI (US)

(72) Inventor: Klaus A. Wieder, Helenville, WI (US)

(21) Appl. No.: 16/487,082

(22) PCT Filed: Feb. 20, 2018
(86) PCT No.: PCT/US2018/018866

§ 371 Date: Aug. 19, 2019

Related U.S. Application Data
(60) Provisional application No. 62/460,145, filed on Feb. 17, 2017.

(51) Int. Cl. B29C 45/64; B29C 45/83

(52) U.S. Cl. CPC B29C 45/64; B29C 45/83

(57) ABSTRACT

A self-lubricating alignment mold or bar lock assembly which has male and female lock halves with slidably contacting engagement surfaces formed with lubricant-retaining recesses deep enough to hold lubricant that re-lubricates the engagement surfaces during slidable contact therebetween shallow enough to be self-cleaning by shedding debris that ordinarily would cause abrasive wear. The recesses are uniformly spaced and arranged into an array of uniformly spaced rows and columns of recesses that define a lubricant-film retaining region of the engagement surface. Recesses form at least 40% of the total area of the engagement surface and overlap adjacent recesses in adjacent rows and columns providing uniform re-lubrication and lubricant distribution. Each recess has a depth no greater than 25 microns deep enough to hold lubricant but shallow enough to shed debris into an adjacent deeper debris well. Each debris well serves as a gravity feed lubricant reservoir that returns lubricant to recesses.

### FIELD

The present invention is directed to an alignment lock assembly configured to retain and re-lubricate its engagement surfaces with applied lubricant longer to reduce wear, and more particularly to a self-lubricating alignment lock assembly that also is of self-cleaning construction to reduce abrasive wear ordinarily caused by debris by cleaning away debris during use and operation.

### BACKGROUND

Mold locks, such as alignment interlocks, are used on reciprocating equipment, such as injection molds, to facilitate alignment of components, namely mold halves, as they are brought together and then moved apart during molding of a part during cycling of the mold during operation. As the mold halves are brought together during closing of the mold during a molding cycle, such alignment interlocks, also known as mold interlocks, are first to make contact and help guide the mold halves into proper alignment as they come together. As the mold is closed, opposed engagement surfaces of each interlock come into slidable contact with one another helping to compensate for mold misalignment of one mold half relative to the other mold half by aligning or realigning the mold halves as they are being brought together so that the cavity formed by the mated mold halves is aligned during injection of molten material, e.g., molten plastic, into the cavity.

While various mold lock arrangements are known, virtually all of them employ a male lock half that slidably registers with a female lock half during closing and opening of the mold during a mold cycle. The female lock half has a male lock receiving channel formed by a pair of spaced apart inwardly facing and opposed male lock engagement surfaces, which can define a male lock receiving receptacle, and the male lock half has an elongate head with a pair of outwardly facing and opposed female lock engagement surfaces slidably received in the channel.

One commonly used mold lock is a mold interlock that is an assembly that employs a female lock half where the male lock receiving channel has an endwall defining a male lock head receiving receptacle, and a male lock half having an outwardly extending head that is received in the receptacle during mold closing. The head of the male lock half has a profile that is generally complementary to the receptacle of the female lock half to facilitate slidable guiding of the head into the receptacle in a manner that also compensates for some misalignment in the mold halves being brought together during closure. Such a male lock head profile typically has one or both leading edges formed with a ramp that facilitates mold-aligning entry of the head into the female receptacle.

As a result of the relatively frequent and rapid cycling of the mold haves being opened and closed over and over again during reciprocating mold operation, engagement between the male lock head half with the female lock half during reciprocation of the head into and out of the female receptacle produces a considerable amount of friction leading to undesirable mold interlock wear. Excessive premature interlock wear over time not only leads to premature interlock replacement or even failure, it also undesirably increases the amount of misalignment between the mold halves that occurs during mold operation. Mold misalignment caused by excessive interlock wear not only can lead to the production of reduced or inferior quality molded parts, it can also result in damage to the mold, such as when the mold halves clash during cycling due to the misalignment.

To prevent these and other interlock wear related problems, mold interlocks in the past needed to be lubricated, which at times undesirably required mold down-time to do so. However, even despite frequent lubrication, excessive premature wear nonetheless still occurred too often because the lubricant frequently did not stay where most needed on the engaging surfaces of the male and female lock halves. This is because the lubricant was frequently “wiped away” by a line or region of contact of the engaging surfaces of the lock halves formed during interlock engagement and disengagement that moved in one direction during engagement during mold closing and in an opposite direction during mold opening.

To try to extend the length of time applied lubrication remained effective, mold interlocks have been made with relatively large, wide and deep grease channels and dimples formed in their engagement surfaces. Because of their size and depth, it can be difficult to remove all of the corrosion-inhibiting oil prior to installation of the interlock on a mold resulting in an oil film left within the channels or dimples, which can undesirably inhibit adhesion of any lubrication applied. Poor lubricant adhesion is problematic as it defeats the very purpose of the channels and dimples because it leads to premature exhaustion or loss of lubricant on the interlock engagement surfaces undesirably causing premature interlock wear.

Just as bad, if not worse, is the fact that the rather large size, width and depth of these grease channels and dimples also cause them to accumulate debris, such as dirt, chips, flakes, grit, and the like, during mold cycling. Accumulation of debris not only reduces grease-holding capacity, undesirably reducing the length of time before application of lubricant is needed, but the debris can be pulled out of the channels and dimples by the wiping action of the slidable moving contact between the interlock engagement surfaces during mold cycling. Unfortunately, accumulated debris pulled out of the channels and dimples typically becomes deposited on the interlock engagement surfaces, which can cause abrasive wear. When this happens, the excessive abrasive wear can not only lead to premature replacement or failure of the interlock, but it typically also undesirably increases tolerances of the interlock disadvantageously reducing the amount of mold misalignment compensation provided by the interlock. Should such abrasion wear induced tolerances increase too much and mold misalignment compensation correspondingly become too poor, it can produce mold misalignment so great during mold closure that it can adversely impact molded component fit, finish and quality.

U.S. Pat. No. 8,821,144, is directed to a mold interlock with non-uniformly arranged rows and columns of relatively large and deeply recessed-donut shaped particle wells or rings in which lubricating grease applied to the interlock accumulates. As with the aforementioned channels and dimples, the particle rings are designed to accumulate grease when the engagement surface of the interlock is lubricated that is used to re-lubricate the engagement surfaces during engagement and disengagement of the interlock during cycling of the mold.

Unfortunately, the non-uniform arrangement of the rows and columns of particle rings also results in engagement surfaces having regions where the particle rings of adjacent rows and columns either do not overlap or do not uniformly overlap. Such non-uniform or lacking overlapping of particle rings of adjacent rows and columns produces non-uniform re-lubrication of the adjacent engagement surface during engagement and disengagement of the interlock during mold cycling. This causes areas of the adjacent engagement surfaces to either be poorly re-lubricated or not be re-lubricated at all during interlock engagement and disengagement during mold cycling. Those regions of the interlock engagement surface where re-lubrication is poor or lacking can prematurely accelerate interlock wear and failure while also undesirably reducing the amount of mold misalignment compensation the interlock can correct during use and operation.

Just as bad, if not worse, is that the particle rings are also so large, wide and/or deep that debris also tends to easily get trapped in them during engagement and disengagement of the interlock during mold cycling. Where too much debris accumulates and is not removed, it reduces the particle ring volume available for grease thereby reducing re-lubrication of areas of the engagement surface adjacent debris-filled rings undesirably increasing interlock wear. Where accumulated debris is discharged from particle rings during interlock engagement and disengagement during mold cycling, the freed debris undesirably causes abrasive wear of the interlock disadvantageously even further accelerating interlock wear. Such accelerated wear not only can require premature interlock replacement or lead to premature interlock failure, it typically also results in the interlock providing less mold misalignment compensation than desired or permitted before replacement or failure. When the interlock is worn so much it cannot provide proper mold misalignment compensation, it can result in the mold halves being misaligned so much when closed that the resultant molded component or components are out of tolerance, are misshapen, or are of such poor quality that they are not suitable for use.

What is needed is an improved mold lock that not only significantly extends how long applied lubricant remains available on the lock to re-lubricate the engagement surfaces of the lock to reduce and preferably minimize wear. What also is needed is such an improved mold lock that minimizes the amount of debris that can become trapped to further minimize wear, particularly abrasive wear.

### SUMMARY

The present invention is directed to a high-lubricity self-cleaning alignment lock assembly, preferably an alignment interlock assembly, such as a mold lock, bar lock, or parting line lock, which is configured to facilitate reciprocating mold alignment, and which employs relatively shallow lubricant-retaining recesses formed in engagement surfaces of the assembly that readily accumulates lubricant, e.g., grease, while preventing accumulation of debris thereby minimizing lock wear and extending lock life during reciprocating mold cycling. The lubricant-retaining recesses define a three-dimensionally contoured lubricant film retaining region of the engagement surfaces of the lock assembly that has a maximum depth shallow enough so a wiping action produced by the engagement surfaces of the lock assembly cleans the recesses of debris, such as dirt, chips, dust, grit, and the like, therefrom while also spreading lubricant accumulated therein along substantially the entire lubricant film retaining region to maintain a lubricant film thereon. The lock assembly can be and preferably is configured with at least one debris repository well formed in or alongside each engagement surface equipped with a three-dimensionally contoured lubricant film retaining region for accumulating debris wiped therefrom into the well producing a self-cleaning lock assembly.

The lock assembly has a male lock half carried by one component of a reciprocating machine, such as a molding machine, which is disposed operable cooperation with a female lock assembly carried by another component of the reciprocating machine that facilitates alignment of the one component, e.g., mold half, relative to the another component, e.g., another mold half, during reciprocating cycling of the components during reciprocating machine, e.g., molding machine, operation. Each lock half has at least one and preferably a pair of engagement surfaces that can slidably contact one another during reciprocating machine, e.g., molding machine, operation. Each engagement surface is configured with a three-dimensionally contoured lubricant film retaining region having relatively shallow recesses configured to accumulate and release lubricant and also to readily shed debris therefrom during the wiping action of opposed engagement surfaces of the lock halves when being in slidable moving contact with one another during reciprocating machine, e.g., molding machine, operation.

Each recess is relatively shallow having a depth no greater than 25 microns and preferably between 25 microns and 5 microns producing a recess deep enough to accumulate lubricant therein that is squeegeed and dispensed by the wiping action to re-lubricate the three-dimensionally contoured lubricant film retaining region while being shallow enough to cause any debris in the recesses to be wiped away by the same wiping action. Each recess is defined by a sidewall and a bottom wall that is generally flat. In a preferred embodiment, each recess is formed of a generally round, circular, oval or oblong pocket recessed into the engagement surface in the three-dimensionally contoured lubricant film retaining region of the engagement surface. In a preferred embodiment, each recess, preferably each pocket, is formed by laser etching or laser cutting with the sidewall defining each recess, preferably each pocket, being an ablation region produced during laser etching or cutting.

There can be and preferably is at least one debris repository well formed in or alongside each engagement surface equipped with a three-dimensionally contoured lubricant film retaining region for accumulating debris wiped therefrom into the well producing a self-cleaning lock assembly. In a preferred embodiment, at least one of the engagement surfaces equipped with a three-dimensionally contoured lubricant film retaining region has debris repository well that is disposed along each side or end of the corresponding adjacent three-dimensionally contoured lubricant film retaining region bracketing the three-dimensionally contoured lubricant film retaining region to collect debris wiped from the three-dimensionally contoured lubricant film retaining region during reciprocating cycling in one direction, e.g., during mold closing, as well as during reciprocating cycling in the opposite direction, e.g., during mold opening.

The recesses, preferably pockets, are uniformly spaced apart from one another forming at least a plurality of pairs, i.e., at least three, rows and columns uniformly spaced from one another and staggered so as to produce a three-dimensionally contoured lubricant film retaining region where each recess, preferably pocket, in each one of the rows or columns overlaps at least 25% and preferably at least 33% of the closest or adjacent-most recess, preferably pocket, of each adjacent one of the rows or columns in or along a direction generally transverse to the row or column. Such an array of uniformly spaced rows and columns of recesses, preferably pockets, each with at least a plurality of pairs, i.e., at least three, recesses, preferably pockets, advantageously produces a three-dimensionally contoured lubricant film retaining region that builds, maintains and re-lubricates a lubricant film thereon during reciprocating machine, e.g., molding machine, operation.

Each debris repository well preferably has a depth greater than that of the maximum depth of the recesses or pockets of the three-dimensionally contoured lubricant film retaining region such that debris wiped free of the three-dimensionally contoured lubricant film retaining region is deposited in an adjacent well where it remains. In one preferred embodiment, each debris repository well has a depth at least twice as great as the maximum depth of the lubricant-retaining recesses or pockets helping ensure debris wiped free of the three-dimensionally contoured lubricant film retaining region and deposited in such a debris repository well remains trapped or collected in the debris repository well. In another preferred embodiment, each such debris repository well has a depth at least three times as great as the maximum depth of the lubricant-retaining recesses or pockets of the three-dimensionally contoured lubricant film retaining region.

One preferred mold lock assembly is a self-lubricating mold lock, such as a mold interlock or bar lock, having at least one mold lock engagement surface that slidably contacts and wipes another mold lock engagement surface during mold cycling with at least one of the engagement surfaces configured with such relatively shallow lubricant-retaining recesses in the form of nanoscale size micro-retention grease retention pockets formed therein that are smaller in size relative to the debris normally encountered during mold cycling to prevent debris from also accumulating therein. The mold lock also is self-cleaning as the micro-retention pockets are nanoscale in size such that the pockets preferably are also shallower in depth relative to such debris to not only help prevent debris accumulation in the pockets, but also so any debris small enough to make it into any of the pockets is readily removed therefrom by a wiping action produced as a sliding line or region of contact between the engaging lock surfaces moves during opening and closing of the mold.

A preferred embodiment of the present invention is directed to a re-lubricating self-cleaning alignment interlock for aligning one component or a reciprocating machine relative to another component of the reciprocating machine during reciprocable movement of one component toward the other component and as the components are coming together preferably in mating contact therewith. A re-lubricating self-cleaning mold interlock of the present invention has a male lock carried by one reciprocating machine component with an elongate outwardly extending alignment-seeking head that is slidably and releasably received in a receptacle formed in a female lock carried by the other reciprocating machine component that is configured to provide at least one lubricant reservoir which lubricant is re-applied on at least one of the contacting surfaces of the male and/or female lock during insertion of the male lock head into the female lock receptacle and/or removal of the head from the receptacle. At least one of the contacting surfaces of the male lock head and/or which define a portion of the female lock receptacle have at least a plurality of pairs, i.e., at least three, of micro-grease retention pockets formed therein distributed throughout at least a substantial portion of the contacting surface(s) for holding grease in each pocket therein that helps maintain a lubricious film of the lubricating grease on one or both contacting surfaces during male lock insertion into or withdrawal from the female lock receptacle in a localized region of and adjacent each pocket. Each one of the micro-grease retention pockets is deep enough to hold lubricating grease when re-lubricated during one of male lock insertion into and/or removal from the female lock receptacle to help maintain a lubricating film of the grease throughout substantially the entire contacting surface(s) of the male and female locks of the interlock. Each one of the grease micro-retention pockets is shallow enough to prevent debris, e.g., chips, dirt, grit, dust, etc., from accumulating or otherwise becoming trapped therein and which preferably is so shallow that such debris is swept out by a debris-cleaning wiping action that occurs when the contacting surfaces of the male lock head and female lock receptacle slidably and movably contact each other during one or both male lock head insertion into and/or removal from the female lock receptacle.

Various other features, advantages, and objects of the present invention will be made apparent from the following detailed description and any appended drawings.

### DRAWING DESCRIPTION

One or more preferred exemplary embodiments of the invention are illustrated in the accompanying drawings in which like reference numerals represent like parts throughout and in which:

FIG. 1 is a top perspective view of a preferred embodiment of a self-lubricating and self-cleaning alignment lock assembly that preferably is a mold lock constructed in accordance with the present invention;

FIG. 2 is a top right perspective view of the mold lock of FIG. 1 illustrating more clearly an array of lubricant-retaining recesses used to re-lubricate engagement surfaces of the lock assembly during engagement and disengagement thereof;

FIG. 3 is a rear right perspective view of the alignment interlock assembly of FIGS. 1 and 2;

FIG. 4 is a top plan view of another preferred embodiment of a self-lubricating and self-cleaning alignment interlock assembly of the invention that is configured with a secondary final precision taper lockup arrangement;

FIG. 5 is an enlarged fragmentary top plan view of a head of the male lock half entering a head-receiving receptacle of the female lock half depicting a male lead-in profile of the head and a female lead-in profile of the receptacle that is configured to provide angular misalignment tolerant alignment during receipt or docking of the head in the receptacle;

FIG. 6 is a front top right perspective view of the generally U-shaped female lock half of the interlock assembly of FIGS. 1-3;

FIG. 7 is a top elevation view of the generally T-shaped male lock half of the interlock assembly of FIGS. 1-3;

FIG. 8 is a bottom front right perspective view of the generally T-shaped male lock half of the interlock assembly of FIGS. 1-3 and 5;

FIG. 9 is a fragmentary view of a lubricant film retaining region of one of the engagement surfaces of the head of the male lock and/or the receptacle of the female lock formed of lubricant-retaining recesses deep enough to provide re-lubrication of the region yet shallow enough to facilitate debris removal during engagement and disengagement of the head with the receptacle;

FIG. 10 is an enlarged fragmentary view of a plurality of lubricant-retaining recesses n the form of debris-shedding lubricant retaining pockets of the lubricant film retaining surface of FIG. 9;

FIG. 11 is a photomicrograph of a portion of an engagement surface of a mold lock illustrating in more detail lubricant-retaining recesses of the present invention in the form of laser-etched debris-shedding lubricant-retaining pockets; and

FIG. 12 is a perspective view of a mold bar lock assembly depicting at least one engagement surface configured with lubricant-retaining recesses that form a lubricant film retaining region of an engagement surface of the bar lock.

Before explaining one or more embodiments of the invention in detail, it is to be understood that the invention is not limited in its application to the details of construction and the arrangement of the components set forth in the following description or illustrated in any appended drawings. The invention is capable of other embodiments, which can be practiced or carried out in various ways. Also, it is to be understood that the phraseology and terminology employed herein is for the purpose of description and should not be regarded as limiting.

### DETAILED DESCRIPTION

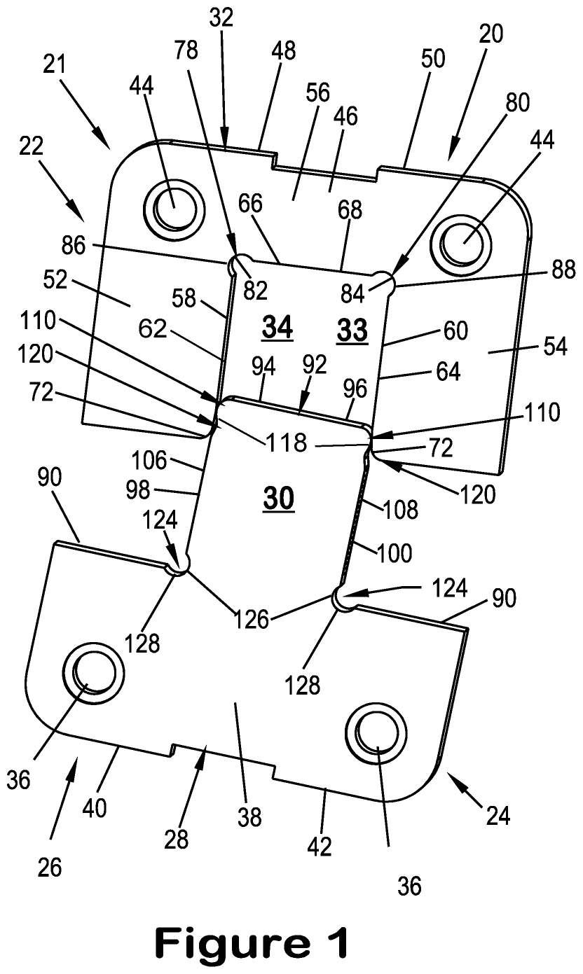

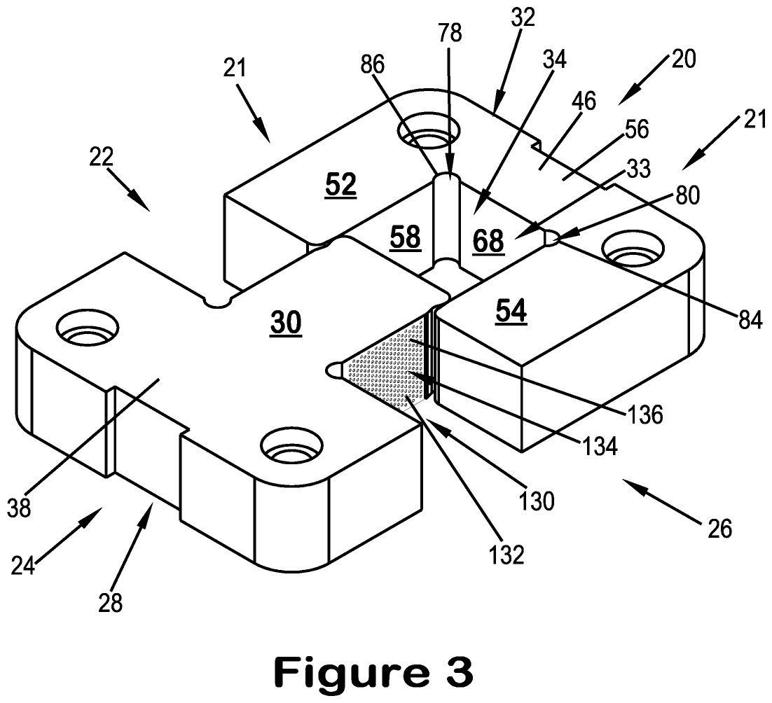

With reference to FIGS. 1-3, present invention is directed to a mold lock 21 that is an alignment interlock 20 that preferably is a mold interlock 22, which more preferably is a mold parting line lock or interlock 24, formed of an alignment interlock assembly 26 having a generally T-shaped male lock half 28 with an outwardly extending head 30 that aligns with a generally U-shaped female lock half 32 during removable receipt of the male lock head 30 in a receptacle 34 defined by a male lock head guide channel 33 formed in the female lock half 32. As discussed in more detail below, one or more surfaces of the male lock head 30 and/or one of more engagement surfaces that define the female lock receptacle 34 are formed with a lubricant film maintaining bearing region that also facilitates debris removal during insertion and/or removal of the male lock head 30 from the female interlock receptacle 34 during use and operation of such an alignment interlock 20 of the present invention. As also discussed below, the head 30 and/or surfaces which define the head guide channel 33 and receptacle 34 operatively cooperate with one another during insertion of the head 30 into the head guide channel 33 and receptacle 34 and/or removal of the head 30 from the receptacle 34 producing a wiping action that not only clears debris from the head 30 and/or surfaces of the receptacle 34 but which also spreads lubricant and/or re-lubricates one of more the head 30 and/or receptacle-defining surfaces. As further discussed in more detail below, one or both of the male lock half 28 and female lock half 32 can be and preferably is configured with one or more recesses or reliefs in which lubricant and/or debris from the male lock head and/or surface(s) which define the female lock receptacle is deposited by a wiping action between the male lock head 30 and one of the surfaces that define the female lock receptacle 34 during insertion of the head 30 into the receptacle 34 and/or removal of the head 30 from the receptacle 34.

With continued reference to FIGS. 1-3, the alignment interlock 20 is configured so that either or both the male lock half 28 and female lock half 32 align with one another as the head 30 is received in the receptacle 34 during reciprocating movement of one of the male lock half 28 and the female lock half 32 relative to the other one of the male lock half 28 and the female lock half 32 during use and operation. A preferred alignment interlock 20 is an interlock assembly 26 mounted to movable parts of a reciprocating machine, such as a multi-part mold of a plastic injection molding machine, with the male lock half 28 removably mounted to one part of the machine and the female lock half 32 removably mounted to another part of the machine.

To facilitate mounting of the male lock half 28, the male lock half 28 has one or more fastener-receiving mounting through bores 36 that extend completely through a base 38 of the lock half 28 that extends along a bottom 40 or outer edge 42 of the lock half 28. To facilitate mounting of the female lock half 32, the female lock half 32 has one or more fastener-receiving mounting through bores 44 that extend completely through a base 46 of the lock 32 that extends along a bottom 48 or outer edge 50 of the lock 32. Where used on a mold, one of the lock halves 28 or 32 of the interlock assembly 26 is mounted to one of the mold halves and the other one of the lock halves 28 or 32 of the interlock assembly 26 is mounted to the other one of the mold halves with the interlock assembly 26 guiding the mold halves into alignment as the head 30 of the male lock half 28 is received in the receptacle 34 formed in the female lock half 32 as the mold halves come together during cycling of the mold.

When used to align mold halves of a plastic injection mold, the male and female lock halves 28 and 32 of such an interlock assembly 26, preferably mold parting line lock or interlock 24, can be and preferably are mounted to respective opposed mold halves of a plastic injection mold in the manner such as shown and disclosed in commonly owned U.S. Pat. No. 7,862,326, the entirety of which is hereby expressly incorporated by reference herein. A plurality of interlock assemblies 26, each preferably a mold parting line lock or interlock 24, preferably is used with each pair of mold halves of the plastic injection mold, with a preferred embodiment employing four such interlock assemblies 26, each preferably a mold parting line lock or interlock 24, which are spaced apart and disposed along each side of the mold halves of the mold in the manner also shown and disclosed in U.S. Pat. No. 7,862,326. In such an arrangement, the male lock half 28 of each one of the four interlocks 26, preferably mold parting line locks or interlocks 24, is mounted to one of the mold halves and the female lock half 32 of each one of the four interlocks 26, preferably mold parting line locks or interlocks 24 in such a manner like that further depicted and described in U.S. Pat. No. 7,862,326.

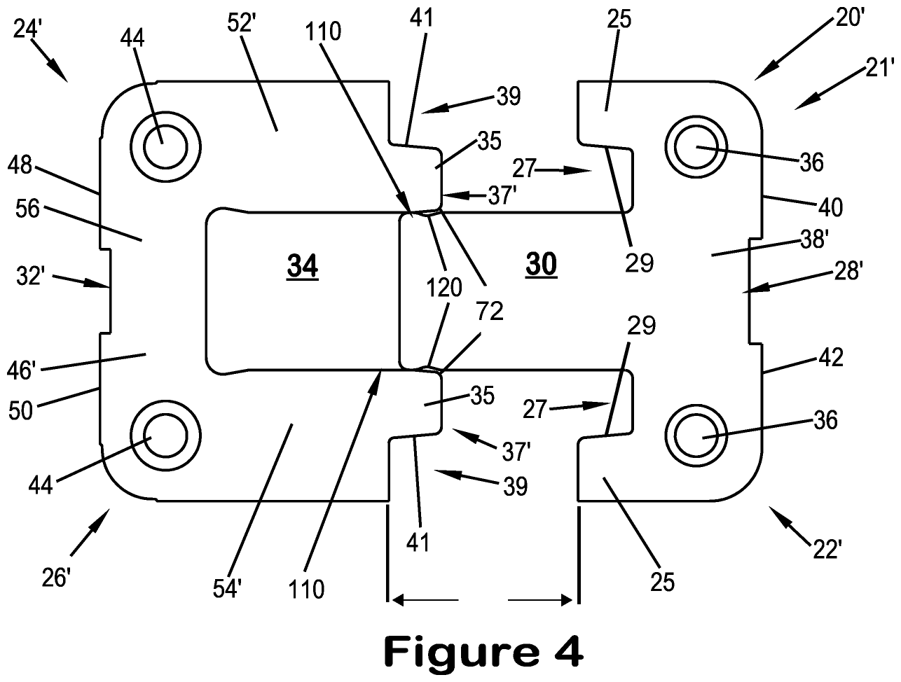

FIG. 4 illustrates another preferred embodiment of an alignment interlock 20′ that preferably is a mold interlock 22′, which more preferably is a mold parting line lock or interlock 24′, which also is formed of an interlock assembly 26′ of a similar but different configuration relative to that shown in FIGS. 1-3. The alignment interlock 20′ shown in FIG. 4 also is configured for use with a mold, preferably a plastic injection mold, having a pair of mold halves with one of the mold halves carrying male lock half 28′ and the other one of the mold halves carrying female lock half 32′, such as also shown and disclosed in U.S. Pat. No. 7,862,326. While the male lock half 28′ shown in FIG. 4 also is generally T-shaped, it has a W-shaped male lock base 38′ configured with a pair of alignment facilitating interlock flanges 25 extending generally parallel with the male lock head 30 and which is spaced from the head 30 on opposite sides of the head 30 defining an interlock channel 27 therebetween. While the generally U-shaped female lock half 32′ shown in FIG. 4 also has a pair of spaced apart and generally parallel lock arms 52′ or 54′ that extend outwardly from the female lock base 46′, the free end 37′ of each arm 52′ and 54′ is not flat or planar but rather has a tapered interlock projection 35 extending outwardly therefrom which is disposed inboard of an adjacent recessed interlock-flange receiving abutment 39. During closing of the mold halves, a secondary precision taper lockup is formed by an acutely inclined or tapered outer sidewall 41 of each interlock projection 35 of female lock half 32′ slidably engages with a complementarily acutely inclined or tapered inner sidewall 29 of each interlock flange 25 of male lock half 28′ providing increased interlocking surface area contact therebetween that advantageously increases the precision of accuracy of alignment when complete mold closure is achieved.

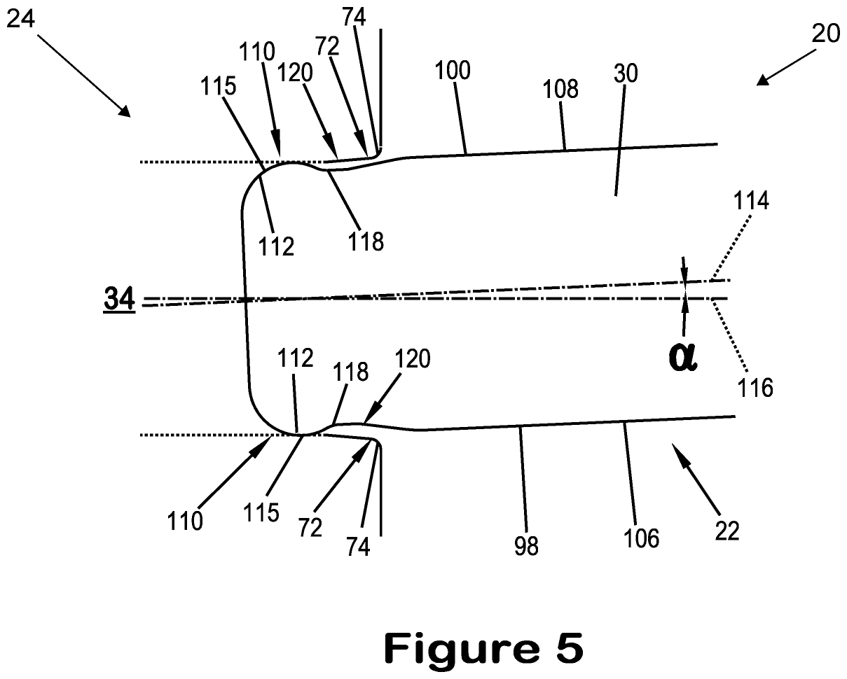

FIG. 5 is discussed in more detail below as it depicts features of a preferred embodiment of a head 30 of a preferred male lock half 28 constructed in accordance with the present invention, and features of a preferred embodiment of a receptacle 34 of a preferred female lock half 32 also constructed in accordance with the present invention that advantageously facilitate self-aligning lockup during mold closing while accommodating greater angular misalignment between the head 30 and receptacle 34 during insertion of the head 30 into the receptacle 34 during alignment interlock assembly lockup during mold closing. FIG. 5 also depicts sliding contact between the head 30 and receptacle 34 during alignment lockup of the alignment interlock assembly 20 of the present invention, which preferably is a mold parting line lock or interlock 24, with such sliding contact serving to clean debris from at least the head 30 and preferably also the sides of the receptacle 34 during mold closing helping to extend life of the interlock assembly 20, e.g. parting line lock or interlock 24.

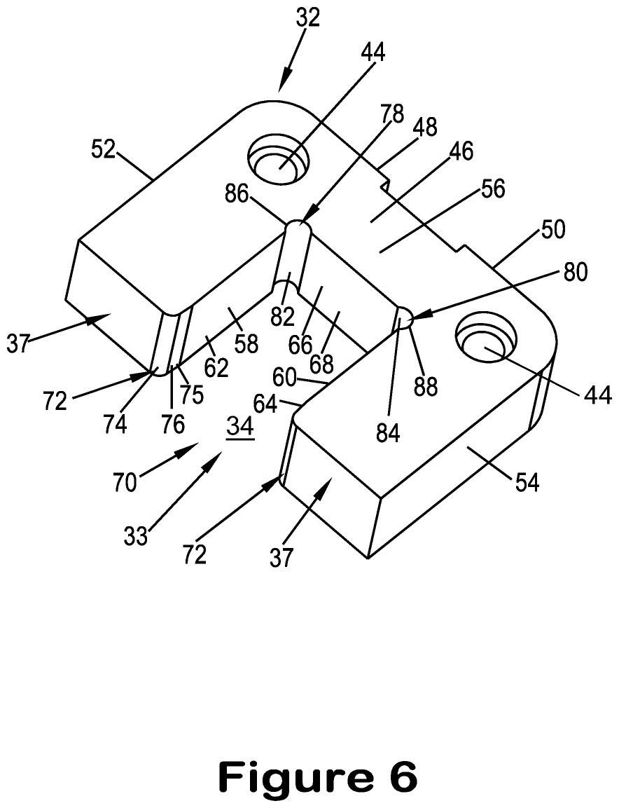

The female lock half 32 shown in more detail in FIG. 6 forms one half of an interlock assembly 26 constructed in accordance with the present invention that preferably is the receiving half of a mold parting lock 24 of the present invention. During use and operation, during mold closing, the head 30 of the male lock half 28 enters the receptacle 34 in the female lock half 32 with the receptacle 34 guiding the head 30 and thereby the male lock half 28 into alignment with the female lock half 32 as the head 30 travels farther into the receptacle 34 until the mold closes. The female lock half 32 is generally U-shaped formed by a pair of elongate spaced apart and generally parallel lock arms 52 and 54 that extend outwardly from the lock base 46 defining alignment receptacle 34 therebetween. Each one of the lock arms 52 and 54 is of generally rectangular cross-section with the head-receiving or male lock-docking receptacle 34 defined by the arms 52 and 54 and a bridge-portion 56 of the base 46 of the female lock half 32 that extends between the arms 52 and 54. The receptacle 34 is further defined by a pair of opposed and generally planar male lock head guiding side surfaces 58 and 60 forming respective sidewalls 62 and 64 of the receptacle 34 interconnected by a male lock head abutment or end surface 66 defining a male lock head stop or endwall 68 of the receptacle 34.

With continued reference to FIG. 6, the receptacle 34 has an enlarged mouth 70 at its entrance with an outwardly tapered male lock head receptacle entry facilitating profile 72 that is formed at or adjacent a free end of each female lock arm 52 and 54 which includes a top or outer generally-right angled corner 74 with an outwardly tapered or inclined portion that transitions to an outwardly tapered receptacle mouth-defining outer surface 75 and upper sidewall segment 76 which in turn transitions to a corresponding generally parallel receptacle sidewall surface 58 and 60. In a preferred receptacle embodiment, the receptacle 34 is widest at its mouth 70 with the width of the receptacle 34 tapering or converging from at or adjacent its mouth 70 causing the receptacle 34 to gradually narrow at or along tapered receptacle sidewall segment 76 defining a misalignment-tolerant receptacle entry facilitating profile 72 and receptacle mouth 70 that helps facilitate entry of the male lock head 30 into the receptacle 34 even when significant misalignment between the male lock half 28 and female lock half 32 is present.

In one preferred embodiment, the upper or outer corner 74 of each misalignment tolerant male lock head receptacle entry facilitating profile 72 is generally planar, tapered and/or inclined in a manner that narrows the width of the receptacle 34 from at or adjacent the mouth 70 of the receptacle 34 the farther back or deeper into the receptacle 34 the generally planar, tapered and/or inclined corner 74 extends. In another preferred embodiment, the upper or outer corner 74 of each misalignment tolerant male lock head receptacle entry facilitating profile 72 is a generally convexly or outwardly radiused corner 74 that is curved and/or inclined in a manner that narrows the width of the receptacle 34 from at or adjacent the mouth 70 of the receptacle 34 the farther back or deeper into the receptacle 34 the radiused or curved corner 74 extends.

With continued reference to FIG. 6, such a misalignment tolerant male lock head receptacle entry facilitating profile 72 is disposed on opposite sides of the open end of the receptacle 34 defining a widened receptacle mouth 70 having a width at the mouth 70 that preferably gradually narrows as the profile 72 tapers or converges to corresponding side surfaces 58 and 60 of respective generally parallel receptacle sidewalls 62 and 64. As indicated above and also depicted in FIG. 6, each profile 72 is formed of top or outer corner 74 with each profile 72 preferably also including tapered or converging substantially planar surface 75 and segment 76 disposed downstream of corner 74 and disposed upstream of corresponding side surfaces 58 and 60 and sidewalls 62 and 64. Each one of the receptacle sidewalls 62 and 64 extends from at or adjacent corresponding profile 72 disposed at or adjacent the receptacle mouth 70 to or adjacent the bottom surface 66 and endwall 68 of the receptacle 34. As further shown in FIG. 6, the bottom surface 66 and endwall 68 of the receptacle 34 preferably is generally perpendicular to both side surfaces 58 and 60 and both sidewalls 62 and 64 of the receptacle 34.

Formed in the bottom corners of the receptacle 34 are diagonally outwardly extending corner reliefs 78 and 80 spaced apart by bottom surface 66 and receptacle endwall 68 with each corner relief 78 and 80 providing a debris repository well 82 and 84 and which can also serve as a lubricant reservoir 86 and 88 during use and operation of interlock assembly 20 that preferably is configured for use as a mold parting line interlock 24. As shown in FIG. 6, one corner relief 78, debris repository well 82 and/or lubricant reservoir 86 and 88 is formed at or adjacent the intersection region between (i) side surface 58 and bottom surface 66, or (ii) sidewall 62 and endwall 68, and the other corner relief 80, debris repository well 84 and/or lubricant reservoir 86 and 88 is formed at or adjacent the intersection region between (i) side surface 60 and bottom surface 66, or (ii) sidewall 60 and endwall 68. Each female lock corner relief 78 and 80 preferably is an outwardly radiused relief that can be and which preferably is formed of a bore that preferably is a round hole that is formed, such as by being drilled, at or adjacent where the bottom surface 66 and receptacle endwall 68 intersect respond side surfaces 60 and 62 and receptacle sidewalls 62 and 64 before relief formation.

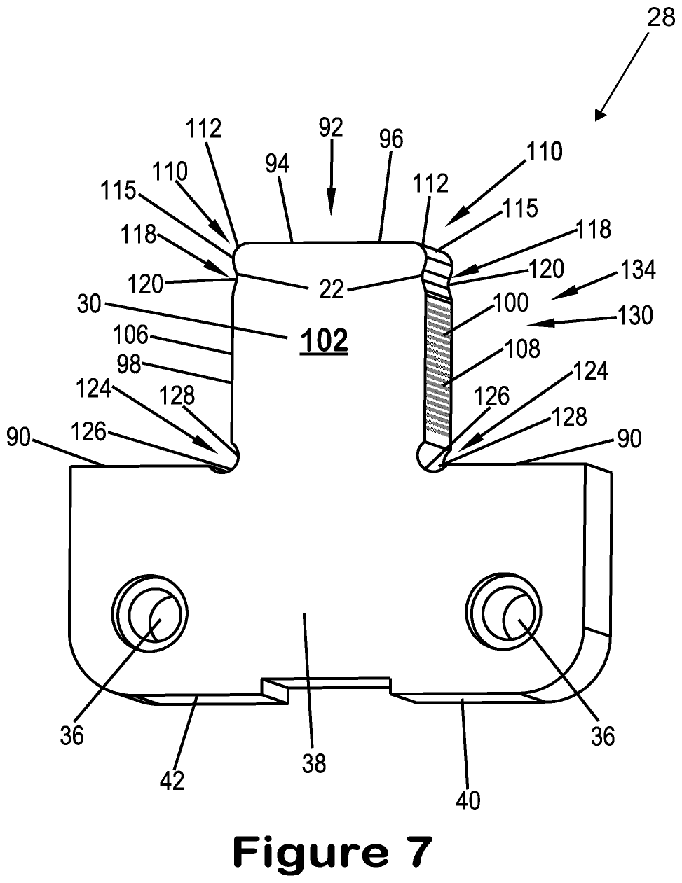

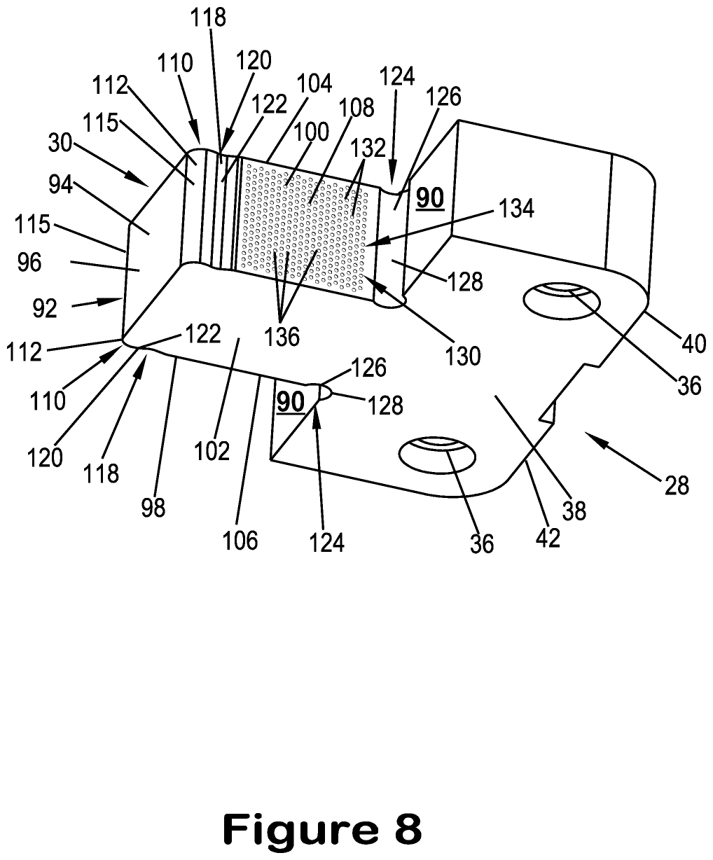

With additional reference to FIGS. 7 and 8, the male lock half 28 is the half of interlock assembly 26 that preferably is the insertion half of a mold parting lock 24 constructed in accordance with the present invention. The male lock half 28 is generally T-shaped and has a transversely elongate base 38 from which extends outwardly an elongate head 30 with the male lock base 38 having an outwardly projecting female lock arm abutment 90 disposed on opposite sides of the head 30. Where the free end 37 of each female lock arm 52 and 54 is generally planar or flat, like that of the female lock half 32 shown in FIG. 6, the abutments 90 of the male lock half 28 preferably are also generally planar or flat like that of the male lock half 28 depicted in FIGS. 7 and 8. Where the free end 37′ of each female lock arm 52′ and 54′ is three dimensionally contoured or three dimensionally configured, the male lock half 28′ has a generally T-shaped configuration like the male lock half 28 of FIGS. 7 and 8 but is further configured with a generally W-shaped base 38′ like that shown in FIG. 4 that has three dimensionally contoured or configured female lock arm abutments 80′ configured to provide secondary final precision taper lockup when mated with the complementarily three-dimensionally configured female lock arm ends 37′ upon mold closing.

With continued reference to FIGS. 7 and 8, the head 30 of the male lock half 28 has a generally rectangular, e.g., square, transverse and longitudinal cross section, and the base 38 also has a generally rectangular, e.g., square, cross section in a direction transverse to the head 30. The head 30 of the male lock half 28 has a free end 92 that can be three dimensionally contoured or three dimensionally configured to mate or register with a correspondingly three dimensionally contoured or three dimensionally configured male lock head abutment surface 66 of the end wall 68 of the receptacle 34 formed in the female lock half 32. In the preferred male lock embodiment shown in FIGS. 6 and 7, the free end 92 of the head 30 of the male lock half 28 has a flat or generally planar outer surface 94 which defines a male lock head end wall or abutment 96 which can and preferably does stop or abut against the generally flat abutment surface 66 of the end wall 68 of the receptacle 34 in the female lock half 32 when the male lock head 30 is fully inserted into the female lock receptacle 34 when alignment interlocking or alignment lockup is completed upon mold closing.

The male lock head 30 is further defined by a pair of spaced apart, generally parallel and generally planar sidewalls 98 and 100 and by a pair of front and rear walls 102 and 104. The head sidewalls 98 and 100 are respectively defined by female lock engagement surfaces 106 and 108, which preferably are generally flat or substantially planar, one surface 106 or 108 of which preferably makes sliding engagement or contact with corresponding surface 58 or 60 of respective receptacle sidewall 62 or 64 during male lock head 30 insertion into or removal from the female lock receptacle 34. The sidewalls 98 and 100 and front and rear walls 102 and 104 of the head 30 extend generally perpendicular relative to the female lock arm abutments 90 of the male lock base 38 and outwardly from the base 38 to or adjacent the end wall 96 of the head 30. The head end wall 96 is generally perpendicular to the head sidewalls 98 and 100 and is also generally perpendicular to the head front and rear walls 102 and 104.

With reference once again to FIG. 5, to achieve positive alignment while accommodating greater misalignment during alignment interlock operation during mold closing, the leading end 92 of the head 30 of the male lock half 28 is configured with a misalignment tolerant interlock engagement facilitating lead-in profile 110 formed at or adjacent where the end wall 96 and sidewalls 98 and 100 of the male lock head 30 intersect at or adjacent a respective outer corner 112 of the head 30. As is depicted in FIG. 5, a male lock half 28 equipped with such a head 30 configured with such misalignment tolerant interlock engagement facilitating lead-in profiles 110 formed at or adjacent each of the outer corners 112 of the head 30 in accordance with the present invention is advantageously able to accommodate greater angular misalignment between the head 30 and female lock receptacle 34 during entry of the head 30 into the receptacle 34. In the preferred but exemplary embodiment shown in FIG. 5, a male lock half 28 having a head 30 configured with such misalignment tolerant interlock engagement facilitating lead-in profiles 110 is able to accommodate greater angular misalignment between a central longitudinal axis 114 of the head 30 and a central longitudinal axis 116 of the receptacle 34 where the angle of misalignment, a, between the head axis 114 and receptacle axis 116 is at least ±2.5° but preferably no greater than ±15° while still ensuring entry of the head 30 into the receptacle 34 in a manner that provides positive alignment interlocking when alignment interlocking or alignment lockup is completed upon mold closing.

A male lock head 30 configured with a preferred misalignment tolerant interlock engagement facilitating lead-in profile 110 in accordance with the present invention has convexly outwardly rounded or radiused outer corners 112 to help prevent the end of the head 30 at or adjacent the corresponding corner 112 contacting part of the female lock half 32 from sticking, binding, clashing or otherwise interfering with head 30 being able to move into the receptacle 34 during alignment interlocking or alignment lockup during mold closing. Such a male lock half 28 made with a head 30 configured with such lead-in profiles 110 coming in contact with an adjacent one of the outer receptacle corners 74 advantageously slides off and/or around it into the receptacle 34 as the rounded or radiused exterior of the lead-in profile 110, i.e., corresponding rounded or radiused outer corner 112, helps prevent binding, sticking, clashing or other interference therebetween. Where the outer corners 74 of the receptacle 34 of the female lock half 32 are also configured with an outwardly tapered male lock head receptacle entry facilitating profile 72, the misalignment tolerant interlock engagement facilitating lead-in profile 110 and outwardly tapered male lock head receptacle entry facilitating profile 72 advantageously operatively cooperate with one another when they come into contact with each during alignment interlocking or alignment lockup of the lock halves 28 and 32 during mold closing while accommodating angular misalignment of at least ±5° and as much as ±10°.

Each lead-in profile 110 of the head 30 is provided or defined by a respective convexly outwardly rounded or radiused outer corner 112 of the head 30. Entry of the head 30 into the receptacle 34 during mold closing can also be facilitated by a recessed concavely rounded relief 118 disposed adjacent to but downstream of outer corner 112 of profile 110. As is best shown in FIG. 6, each recessed concavely rounded relief 118 can be concavely radiused having a radius of curvature that ensures the relief 118 will be substantially smooth in contour very much like the substantially smooth outer contour of each convexly outwardly rounded or radiused outer corner 112.

Each convexly outwardly rounded or radiused outer corner 112 of the head 30 is elongate and generally parallel to the other convexly outwardly rounded or radiused outer corner 112 of the head 30 with one outer corner 112 formed in one of the receptacle wall contacting sidewalls 98 of the head 30 being generally oppositely outwardly extending and parallel to the other outer corner formed in the other one of the receptacle wall contacting sidewalls 100 of the head 30. As such, head 30 is equipped with a pair of oppositely outwardly projecting, generally parallel and elongate convexly outwardly rounded or radiused outer corners 112 each of which is or defines an elongate convexly outwardly rounded or radiused lead-in profile rib 115. The elongate convexly outwardly rounded or radiused lead-in profile ribs 115 are generally parallel with one another with one of the ribs 115 formed of the outer corner 112 of one of the head sidewalls 98 and the other one of the ribs 115 formed of the outer corner 112 of the other one of the head sidewalls 98.

The head 30 preferably also has a pair of the recessed reliefs 118 that are parallel with one another and disposed on opposite sides of the head 30 with one of the reliefs 118 preferably formed in one of the receptacle sidewall contacting head sidewalls 98 and the other one of the reliefs 118 preferably formed in the other one of the receptacle sidewall contacting head sidewalls 100. Like the smoothly rounded or radiused outer corners 112 or outer lead-in profile ribs 115 of the male lock head lead-in profiles 72, each recessed relief 118 also is smoothly concavely radiused or continuously smoothly rounded with no sharp corners, ridges or any other interruptions to facilitate smooth relative motion between the head 30 and an adjacent contacting outer receptacle corner 74 that comes into contact therewith during insertion of the head 30 into the receptacle 34.

Each recessed concavely rounded or concavely radiused relief 118 can be configured to help accommodate angular misalignment between the head 30 and receptacle 34 by providing clearance in which part of the outer receptacle corner 74 can pass, and even rotate, during relative motion between the head 30 and outer receptacle corner 74 during insertion of the head 30 into the receptacle 34. In the preferred male lock embodiment shown in FIGS. 6-8, each one of the recessed concavely rounded or concavely radiused relief 118 preferably does help accommodate angular misalignment between the head 30 and receptacle 34 by providing clearance in which part of the outer receptacle corner 74 can pass, and even rotate, during relative motion between the head 30 and outer receptacle corner 108 during insertion of the head 30 into the receptacle 34. Where the male lock half 28 has such reliefs 118 formed in opposite sidewalls 98 and 100 of the head 30 and configured with such lead-in profiles 110, e.g., elongate convexly outwardly rounded or radiused ribs 115, at opposite outer corners 112 of the head 30, male lock half 28 advantageously is of a bidirectional misalignment tolerant construction which can advantageously tolerate angular misalignment between the head 30 and receptacle 34 in either direction relative to the receptacle centerline or center axis 114.

Even where one or both of the male lock head reliefs 118 does not provide nor is configured to provide angular misalignment compensation, each relief 118 provides a debris repository well 120 in the head 30 which receives debris wiped or scraped from adjacent corresponding surface 106 or 108 of respective head sidewall 98 or 100 during insertion of the head 30 into the receptacle 34 and/or removal of the head 30 from the receptacle 34. Each one of the debris repository well 120 defined by corresponding relief 118 preferably is elongate, extends substantially the entire width of the head sidewall 98 and/or 100 in which it is formed and are generally parallel with each other with one well 120 formed in one head sidewall 98 and the other well 120 formed in the other head sidewall 100.

During at least one of insertion of the head 30 into the receptacle 34 and removal of the head 30 from the receptacle 34, sliding point contact between surface 106 or 108 of respective head sidewall 98 or 100 and corresponding surface 58 or 60 of the receptacle sidewall 62 or 64 wipes or scrapes debris that has accumulated on one or both contacting sidewall surfaces 98 or 100 and/or 58 or 60 into respective adjacent debris deposit repository well 120. During at least one of insertion and removal, contact between surface 106 or 108 of respective head sidewall 98 or 100 and corresponding surface 58 or 60 of the receptacle sidewall 62 or 64 preferably is line contact that more efficiently wipes or scrapes debris into respective adjacent debris deposit repository well 120 by wiping or scraping each one of the contacting surfaces 98 or 100 and/or 58 or 60 across substantially the entire width of the contacting surfaces 98 or 100 and/or 58 or 60. Depending on the orientation of the head 30 of the male lock half 28 and the receptacle 34 of the female lock half 32 relative to gravity, each relief 118 or debris deposit repository well 120 can also be a recessed lubricant well 122 (FIGS. 5 and 6) in which lubricant deposited during debris cleaning wiping or scraping during head insertion or removal can reflow along the corresponding adjacent surface 106 or 108 of the head sidewall 98 or 100 in which the relief 118, debris deposit repository well 120, or lubricant well 122 is formed.

The male lock half 28 can have and preferably also does have a recessed relief 124 at the root of the head 30 at or adjacent where each head sidewall 98 and 100 intersects the base 38 of the male lock half 28. In at least one preferred male lock embodiment, the recessed lock head root relief 124 defines a debris-receiving repository well 126 in which debris wiped or scraped from contacting surfaces 98 or 100 and/or 58 or 60 of the head 30 and/or receptacle 34 during at least one of insertion of the head 30 into the receptacle 34 and removal of the head 30 from the receptacle 34. In at least one other preferred male lock embodiment, the recessed lock head root relief 124 defines a lubricating reservoir 128 from which lubricant flows via gravity along surfaces 98 or 100 and/or 58 or 60 of the head 30 and/or receptacle 34 re-lubricating one or more of the surfaces 98 or 100 and/or 58 or 60 of the head 30 and/or receptacle 34 during alignment interlock assembly operation preferably including during at least one of insertion of the head 30 into the receptacle 34 and removal of the head 30 from the receptacle 34.

At least one of the receptacle-contacting sidewall surfaces of the head 30 of the male lock half 28 and/or at least one of the head-contacting sidewall surfaces that define or otherwise form part of the receptacle 34 of the female lock half 32 is configured with an engagement surface having a microscopically three-dimensionally contoured lubricant film retaining region 130 which is shown formed in the outer surface 108 of the sidewall 100 of the head 30 of the male lock half 28 illustrated in FIG. 8. With continued reference to FIG. 8, the three-dimensionally contoured lubricant film retaining region 130 preferably is a nanoscale three-dimensionally contoured lubricant film retaining region 130 have at least a plurality, preferably at least a plurality of pairs, i.e., at least three, of lubricant retaining recesses 132 formed in at least one of the outer surfaces 106 and/or 108 of corresponding sidewalls 98 and/or 100 of the head 30 of the male lock half 28. Each one of the recesses 132 has a bottom or bottom wall 133 and can be bounded at least part of the way about its extent or circumference by a wall or sidewall 135. Each one of the recesses 132 is of nanoscale size and has a depth no greater than 25 microns, preferably no greater than about 20 microns (20 microns±2.5 microns), and more preferably no greater than about 15 microns (15 microns±2.5 microns) so that the wiping action from sliding contact between one of the male lock sidewall engagement surfaces 106 or 108 and a corresponding one of the receptacle sidewall surfaces 58 or 60 carries with it abrasive particles in the recesses 132 having a size of at least 25 microns sweeping them into at least one of the recessed debris repository wells 120 and/or 126 formed in the head 30 of the male lock half 28 and/or one of the recessed debris repository wells 82 and/or 84 formed in the receptacle 34 of the female lock half 32 during insertion of the male lock head 30 into the female lock receptacle 34 and/or during removal of the head 30 from the receptacle 34. As a result, metal particles having a size of between 25 microns and 50 microns, which typically accelerate male lock head 30 and/or female lock receptacle 34 wear are wiped or swept free of the engagement surfaces 106 and/or 108 of the head 30 and/or the contacting surfaces 58 and/or 60 of the receptacle 34 significantly extending the life of the alignment interlock 20, preferably mold parting line lock or interlock 24. Such debris removal that has become deposited in the nanoscale sized lubricant retaining recesses 132 of nanoscale contoured lubricant film retaining region 130 is preferably is performed during each insertion of the head 30 into the receptacle 34 and/or during each removal of the head 30 from the receptacle 34 during cycling of the mold while advantageously leaving at least some of the previously applied lubricant disposed in the recesses 132. As a result, a lubricant film 134 that preferably is a hydrocarbon or petroleum based lubricating grease is maintained on the lubricant film retaining region 130 and in the recesses 132 while metal particles, shavings and other particles of debris having a size greater than 25 microns which can and typically do extend outwardly beyond the lubricant film are removed therefrom thereby preventing them from abrasively wearing the head 30 and/or receptacle 34 during mold cycling.

Each debris repository well 82, 84, 120 and 126 has a depth at least a plurality of times, preferably at least a plurality of pairs, i.e., at least three, of times the maximum depth of the recesses 132 to ensure that debris squeegeed or wiped from the lubricant film retaining region 130 into a well 82, 84, 120 and 126 stays in the well 82, 84, 120 and 126. In a preferred embodiment, each well 82, 84, 120 and 126 has a depth that is at least five times and preferably at least ten times the depth of the recesses 132 that define the lubricant film retaining region 130 so that debris from shed from the recesses 132 during wiping of the engagement surface during mold lock engagement and disengagement is retained in the well 82, 84, 120 and 126 thus reducing, minimizing and preferably substantially completely preventing abrasive wear. In addition, each well 82, 84, 120 and 126 can and preferably does define or serve as a gravity feed lubricant reservoir 86, 88, and 128 that returns lubricant swept with debris into the well 82, 84, 120, and 126 back to the lubricant film retaining region 130 of the corresponding engagement surface to help re-lubricate the engagement surface and help maintain the lubricant film 130 in or on the lubricant film retaining region 130.

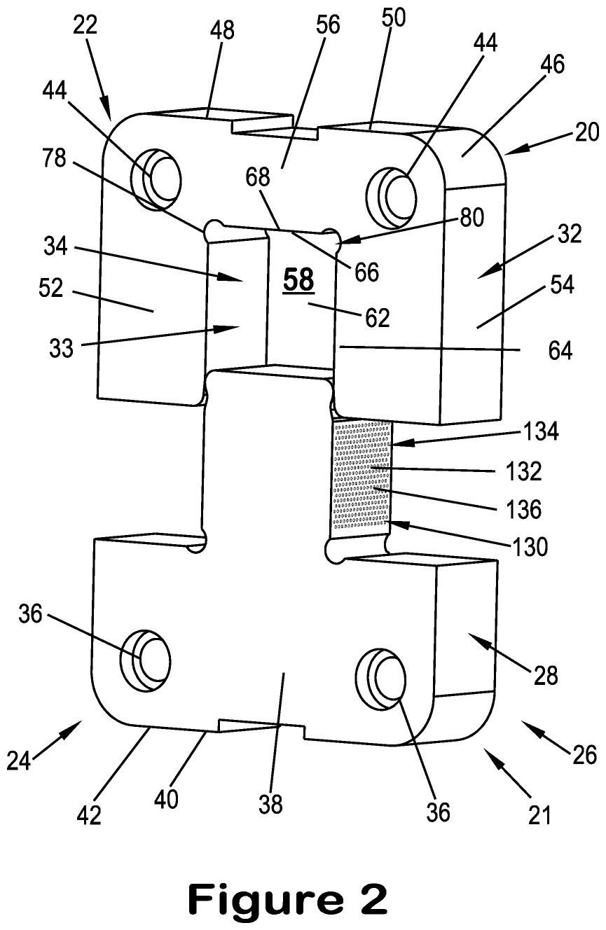

As is shown in FIGS. 2, 8 and 9, substantially the entire surface 58 and/or 60 of each receptacle sidewall 62 and/or 64 and/or substantially the entire surface 106 and/or 108 of each lock head sidewall 98 and/or 100 have spaced apart nanoscale sized lubricant retaining recesses 132 formed therein that are distributed throughout that transform each into such a three-dimensionally contoured lubricant film retaining region 130 with only one such region 130 shown in FIGS. 2 and 8 formed in or of engagement surface 108 of male lock head sidewall 100. In a preferred embodiment, each recess 132 is a generally circular, round, oval or oblong shallow debris shedding lubricant retaining pocket 136 with each lubricant film retaining region 130 formed in or of each one or more of aforementioned lock head and/or receptacle surfaces 58, 60, 106 and/or 108 have at least a plurality, preferably at least a plurality of pairs, i.e., at least three, of the recesses 132, preferably round, circular, oval or oblong pockets 136, per square centimeter of surface area of each lubricant film retaining region 130 of lock halves 28 and/or 32. In one such preferred embodiment, each one of the recesses 132 have a width or radius of no more than 3 millimeters, preferably no more than 2 millimeters, and more preferably no more than about 1 millimeter. In another preferred embodiment, each recess 132 is a generally circular, round, oval or oblong shallow debris shedding pocket 136 with each lubricant film retaining region 130 formed in or of each one or more of aforementioned lock head and/or receptacle surfaces 58, 60, 106 and/or 108 have at least one of the recesses 132, preferably at least one of the pockets 136, per square millimeter of surface area of each lubricant film retaining region 130 of lock halves 28 and/or 32. In another such preferred embodiment, each one of the recesses 132 have a width or radius of no more than 1 millimeter, preferably no more than 0.75 millimeters, and more preferably no more than about 0.5 millimeters. In still another preferred embodiment, each recess 132 is a generally circular, round, oval or oblong shallow debris shedding pocket 136 with each lubricant film retaining region 130 formed in or of each one or more of aforementioned lock head and/or receptacle surfaces 58, 60, 106 and/or 108 have at least a plurality of the recesses 132, preferably at least a plurality of the pockets 136, per square millimeter of surface area of each lubricant film retaining region 130 of lock halves 28 and/or 32. In another such preferred embodiment, each one of the recesses 132 have a width or radius of no more than 0.75 millimeter, preferably no more than 0.50 millimeters, and more preferably no more than about 0.25 millimeters. As previously indicated, each one of the recesses 132 or pockets 136 has a depth no greater than about 25 microns (25 microns±2.5 microns), preferably no greater than about 20 microns (20 microns±2.5 microns), and more preferably no greater than about 15 microns (15 microns±2.5 microns). In a preferred embodiment, each one of the recesses 132 or pockets 136 has a depth of no greater than 25 microns and preferably has a depth of between 25 microns and 5 microns.

The male lock half 28 and female lock half 32 preferably are made of a metal, such as an alloyed steel, preferably A2 high speed steel, K340 steel, such as BOHLER K340 ECOSTAR and/or ISODUR steel, or D2 tool steel, with the outer surfaces 58, 60, 106 and/or 108 of the male lock head and receptacle sidewalls treated, preferably heat treated and/or plasma treated to a hardness of at least a 55 Rockwell C hardness, preferably at least a 58 Rockwell C hardness, and more preferably at least a 60 Rockwell C hardness. These surfaces of one or both lock halves 28 and/or 32 can be hardened, preferably via a cryogenic treatment after an initial hardening treatment step, such as after being heat treated and/or plasma treated, to achieve such a high Rockwell C hardness of at least 55 Rockwell C hardness, preferably at least a 58 Rockwell C hardness, and more preferably at least a 60 Rockwell C hardness. Such a combination of recess or pocket depth, density, spacing, surface hardness and steel material choice advantageously work synergistically to produce an extremely long life lower male lock half 28 and female lock half 32 of the present invention that lasts even longer when lubricated with a petroleum-based high temperature extreme pressure grease lubricant that preferably is comprised of a lithium complex and which meets or exceeds NLGI 2 grade requirements.

In another preferred embodiment, at least one of the receptacle-contacting sidewall surfaces of the head 30 of the male lock half 28 and/or at least one of the head-contacting sidewall surfaces that define or otherwise form part of the receptacle 34 of the female lock half 32 is configured with such a microscopically three-dimensionally contoured lubricant film retaining region 130 like that formed in the outer surface 108 of the sidewall 100 of the head 30 of the male lock half 28 illustrated in FIG. 8. As shown in FIG. 8, the three-dimensionally contoured lubricant film retaining region 130 preferably is a nanoscale three-dimensionally contoured lubricant film retaining region 130 have at least a plurality, preferably at least a plurality of pairs, i.e., at least three, of nanoscale-sized lubricant retaining recesses 132 formed in at least one of the outer surfaces 106 and/or 108 of corresponding sidewalls 98 and/or 100 of the head 30 of the male lock half 28 with each one of the nanoscale recesses 132 having a depth no greater than 18 microns, preferably no greater than 15 microns, and more preferably no greater than 12 microns so that the wiping action from sliding line contact between one of the male lock sidewall surfaces 106 or 108 and a corresponding one of the receptacle sidewall surfaces 58 or 60 carries with it abrasive particles in the recesses 132 having a size of at least 15 microns sweeping them into at least one of the recessed debris repository wells 120 and/or 126 formed in the head 30 of the male lock half 28 and/or one of the recessed debris repository wells 82 and/or 84 formed in the receptacle 34 of the female lock half 32 during insertion of the male lock head 30 into the female lock receptacle 34 and/or during removal of the head 30 from the receptacle 34. As a result, metal particles having a size of between 15 microns and 50 microns, which typically would accelerate male lock head 30 and/or female lock receptacle 34 wear are wiped or swept from of the contacting surfaces 106 and/or 108 of the head 30 and/or the contacting surfaces 58 and/or 60 of the receptacle 34 into one of the debris repository wells 82, 84, 120, and/or 126 significantly extending the life of the alignment interlock 20, preferably mold parting line lock or interlock 24. Such removal of debris that has become deposited in the nanoscale sized lubricant retaining recesses 132 of nanoscale contoured lubricant film retaining region 130 is preferably is performed during each insertion of the head 30 into the receptacle 34 and/or during each removal of the head 30 from the receptacle 34 during cycling of the mold while advantageously leaving at least some of the previously applied lubricant disposed in the recesses 132. As a result, a lubricant film 134 that preferably is a hydrocarbon or petroleum based lubricating grease is maintained on the lubricant film retaining region 130, including within the recesses 132, while metal particles, shavings and other particles of debris having a size greater than 15 microns are removed therefrom thereby preventing them from abrasively wearing the head 30 and/or receptacle 34 during alignment interlock assembly use and operation during mold cycling.

At least one of the receptacle-contacting sidewall surfaces of the head 30 of the male lock half 28 and/or at least one of the head-contacting sidewall surfaces that define or otherwise form part of the receptacle 34 of the female lock half 32 is configured with a microscopically three-dimensionally contoured lubricant film retaining region 130 which is shown formed in the outer surface 108 of the sidewall 100 of the head 30 of the male lock half 28 illustrated in FIG. 8. With continued reference to FIG. 8, the three-dimensionally contoured lubricant film retaining region 130 preferably is a nanoscale three-dimensionally contoured lubricant film retaining region 130 have at least a plurality, preferably at least a plurality of pairs, i.e., at least three, of nanoscale sized lubricant retaining recesses 132 formed in at least one of the outer surfaces 106 and/or 108 of corresponding sidewalls 98 and/or 100 of the head 30 of the male lock half 28 with each one of the nanoscale recesses 132, e.g. pockets 136, is laser etched having a depth no greater than 18 microns, preferably no greater than 15 microns, and more preferably no greater than 12 microns so that the wiping action from sliding contact between one of the male lock sidewall surfaces 106 or 108 and a corresponding one of the receptacle sidewall surfaces 58 or 60 carries with it abrasive particles in the recesses 132 having a size of at least 25 microns sweeping them into at least one of the recessed debris repository wells 120 and/or 126 formed in the head 30 of the male lock half 28 and/or one of the recessed debris repository wells 82 and/or 84 formed in the receptacle 34 of the female lock half 32 during insertion of the male lock head 30 into the female lock receptacle 34 and/or during removal of the head 30 from the receptacle 34. As a result, metal particles having a size of between 25 microns and 50 microns, which typically accelerate male lock head 30 and/or female lock receptacle 34 wear are wiped or swept free of the contacting surfaces 106 and/or 108 of the head 30 and/or the contacting surfaces 58 and/or 60 of the receptacle 34 significantly extending the life of the alignment interlock 20, preferably mold parting line lock or interlock 24. Such debris removal that has become deposited in the nanoscale sized lubricant retaining recesses 132 of nanoscale contoured lubricant film retaining region 130 is preferably is performed during each insertion of the head 30 into the receptacle 34 and/or during each removal of the head 30 from the receptacle 34 during cycling of the mold while advantageously leaving at least some of the previously applied lubricant disposed in the recesses 132. As a result, a lubricant film 134 that preferably is a hydrocarbon or petroleum based lubricating grease is maintained on the lubricant film retaining region 130 and in the recesses 132 while metal particles, shavings and other particles of debris having a size greater than 25 microns which can and typically do extend outwardly beyond the lubricant film are removed therefrom thereby preventing them from abrasively wearing the head 30 and/or receptacle 34 during mold cycling.

As is shown in FIGS. 2, 8 and 9, substantially the entire surface 58 and/or 60 of each receptacle sidewall 62 and/or 64 and/or substantially the entire surface 106 and/or 108 of each lock head sidewall 98 and/or 100 have spaced apart nanoscale sized lubricant retaining recesses 132 formed therein that are distributed throughout that transform each into such a three-dimensionally contoured lubricant film retaining region 130 with only one such surface 130 shown in FIGS. 2 and 8 formed in or of surface 108 of male lock head sidewall 100. In a preferred embodiment, each recess 132 is a laser-etched or laser-cut generally circular, round, oval or oblong shallow debris shedding lubricant retaining pocket 136 with each lubricant film retaining region 130 formed in or of each one or more of aforementioned lock head and/or receptacle surfaces 58, 60, 106 and/or 108 have at least a plurality, preferably at least a plurality of pairs, i.e., at least three, of the recesses 132, preferably round, circular, oval or oblong pockets 136, per square centimeter of surface area of each lubricant film retaining region 130 of lock halves 28 and/or 32. In one such preferred embodiment, each one of the recesses 132 have a width or radius of no more than 3 millimeters, preferably no more than 2 millimeters, and more preferably no more than about 1 millimeter. In another preferred embodiment, each recess 132 is a generally circular, round, oval or oblong shallow debris shedding pocket 136 with each lubricant film retaining region 130 formed in or of each one or more of aforementioned lock head and/or receptacle surfaces 58, 60, 106 and/or 108 have at least one of the recesses 132, preferably at least one of the pockets 136, per square millimeter of surface area of each lubricant film retaining region 130 of lock halves 28 and/or 32. In another such preferred embodiment, each one of the recesses 132 have a width or radius of no more than 1 millimeter, preferably no more than 0.75 millimeters, and more preferably no more than about 0.5 millimeters. In still another preferred embodiment, each recess 132 is a generally circular, round, oval or oblong shallow debris shedding pocket 136 with each lubricant film retaining region 130 formed in or of each one or more of aforementioned lock head and/or receptacle surfaces 58, 60, 106 and/or 108 have at least a plurality of the recesses 132, preferably at least a plurality of the pockets 136, per square millimeter of surface area of each lubricant film retaining region 130 of lock halves 28 and/or 32. In another such preferred embodiment, each one of the recesses 132 have a width or radius of no more than 0.75 millimeter, preferably no more than 0.50 millimeters, and more preferably no more than about 0.25 millimeters. As previously indicated, each one of the recesses 132 or pockets 136 has a depth of no greater than 25 microns, preferably no greater than about 20 microns, and more preferably no greater than 15 microns. The male lock half 28 and female lock half 32 preferably are made of a metal, such as an alloyed steel, preferably A2 high speed steel, K340 steel, such as BOHLER K340 ECOSTAR and/or ISODUR steel, or D2 tool steel, with the outer surfaces 58, 60, 106 and/or 108 of the male lock head and receptacle sidewalls treated, preferably heat treated and/or plasma treated to a hardness of at least a 55 Rockwell C hardness, preferably at least a 58 Rockwell C hardness, and more preferably at least a 60 Rockwell C hardness. These surfaces of one or both lock halves 28 and/or 32 can be hardened, preferably via a cryogenic treatment after an initial hardening treatment step, such as after being heat treated and/or plasma treated, to achieve such a high Rockwell C hardness of at least 55 Rockwell C hardness, preferably at least a 58 Rockwell C hardness, and more preferably at least a 60 Rockwell C hardness. Such a combination of recess or pocket depth, density, spacing, surface hardness and steel material choice advantageously work synergistically to produce an extremely long life lower male lock half 28 and female lock half 32 of the present invention that lasts even longer when lubricated with a petroleum-based high temperature extreme pressure grease lubricant that preferably is comprised of a lithium complex and which meets or exceeds NLGI 2 grade requirements.

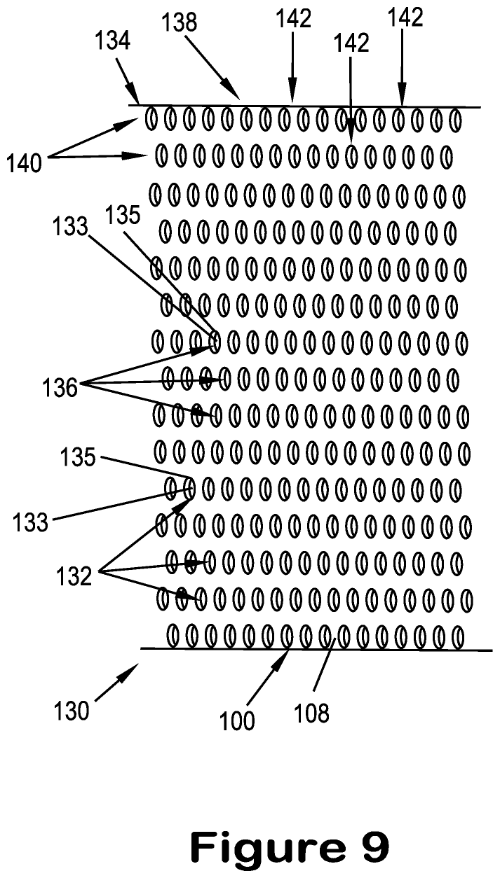

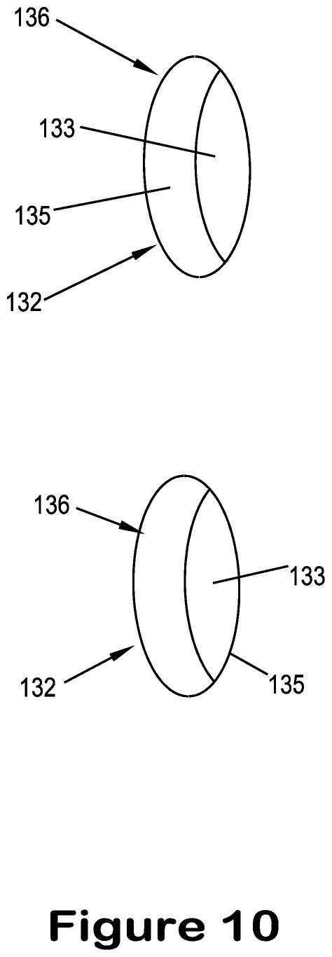

With continued reference to FIGS. 8-11, a male lock head outer engagement surface is configured with round laser etched debris-shedding lubricant retaining pockets 136 having a debris-shedding shallow depth of no greater than about 12 microns, each pocket 136 preferably having a depth of between 10-12 microns, with such round or circular pockets being disposed in an array 138 (FIG. 9) of such pockets formed of at least a plurality of pairs, i.e., at least three, rows 140 and columns 142 of pockets 136 staggered and distributed substantially uniformly throughout the entire engagement surface of the lock head sidewall that comes into contact with a corresponding outer surface of the guide channel or receptacle-defining sidewall of the female lock half during male lock head insertion into the female lock receptacle and/or removal of the male lock head from the female lock receptacle. If desired, the outer surfaces of each male lock head sidewall can be laser etched with such shallow nano-depth pockets, each having a debris-shedding shallow depth of no greater than about 12 microns, each pocket preferably having a depth of between 10-12 microns. If desired, the outer surface of one or both of the receptacle-defining sidewalls of the female lock can also be laser etched with such shallow debris-shedding lubricant-retaining nano-pockets each having a debris-shedding shallow depth of no greater than about 12 microns, with each pocket preferably having a depth of between 10-12 microns.

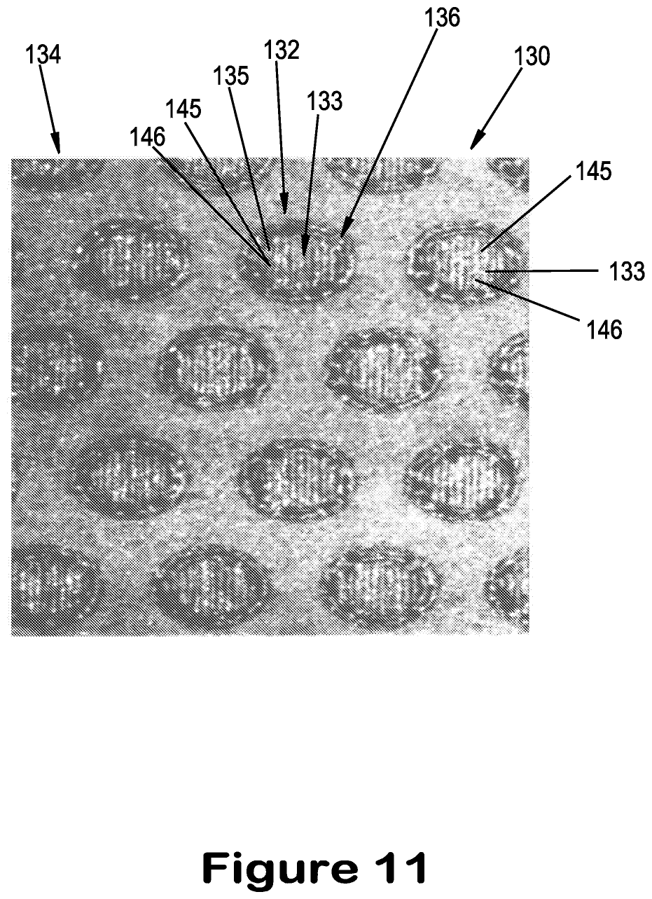

With reference to FIG. 11, each pocket 136 is formed of a three-dimensionally contoured oil-retaining nano-surface etched in each pocket 136 forming a bottom wall 133 formed of generally uniformly spaced apart channels or striations 145 which can be and preferably elongate and can be and preferably also are generally parallel with one another. Such channels or striations 145 recessed within the bottom or floor 133 of each pocket 136 produces a roughened lubricant, e.g. oil or grease, retaining surface 146 that helps retain lubricant therein while also advantageously helping to produce a hydrodynamic bearing or hydrodynamic bearing lubricant film 134 in the lubricant film retaining region 130 of the corresponding engagement surface. One such preferred but exemplary round, e.g., circular, laser-etched pocket 136 has a depth of at least 15 microns, preferably at least 12 microns, preferably between about 10 microns and 12 microns, which the inner surface, bottom or floor 133 of each pocket 136 being nanoscopically roughened, such as in the manner illustrated and discussed above, by the laser etching process used to form each pocket 133 that produces a roughened bottom wall or pocket floor 146 to which lubricant better remains adhered via surface tension.

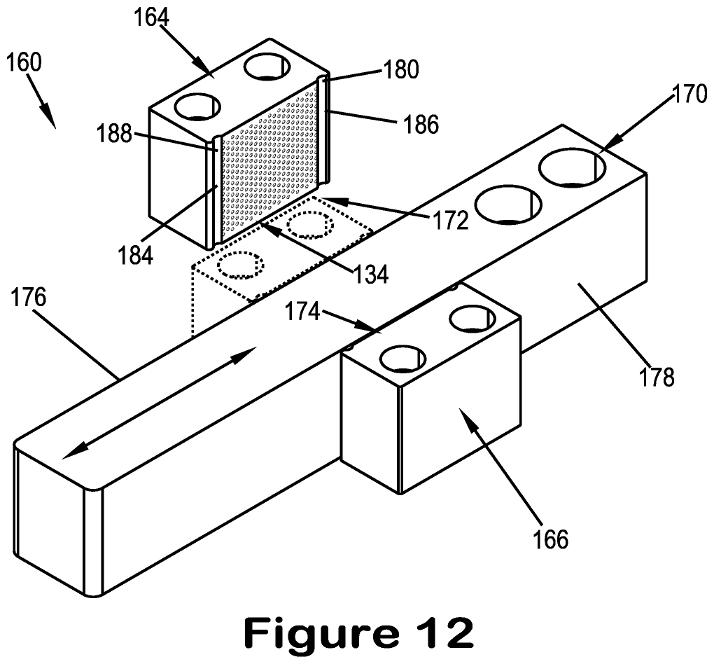

FIG. 12 illustrate a bar lock assembly 160 also constructed in accordance with the present invention having a female lock arrangement 162 formed of a pair of generally parallel spaced apart bars 164, 166 defining a male lock head guide channel 168 that receives a reciprocable male lock head 170. The female lock bars 164, 166 have a pair of opposed engagement surfaces 172, 174 that face each other and towards a respective one of a pair of oppositely outwardly facing engagement surfaces 176, 178 of the male lock head 170. With respect to the bar 164 exploded from the bar lock assembly 160, the engagement surface of each bar 164, 166 has a lubricant film retaining region 134 defined by at least a plurality of pairs, i.e. at least three, recesses 132, preferably pockets 136, in accordance with that discussed above with respect to the mold lock assembly of FIGS. 1-11. Each lubricant film retaining region 134 preferably also is bracketed by a corresponding one of a pair debris repository wells 180, 182 each of which also can define or serve as a lubricant supply reservoir 184,186.

A mold alignment interlock assembly of the present invention includes a generally T-shaped male mold lock that is slidably guided into a receptacle formed in a generally U-shaped female mold lock bringing the male and female mold locks into alignment with one another and the mold halves being brought together. The mold interlock assembly is configured to wipe debris from shallow nano-recesses or nano-pockets shallow enough to shed debris when wiped therefrom during sliding line contact between a surface of at least one of the male lock head sidewalls and/or at least one of the female-lock receptacle defining sidewalls with such pockets laser etched therein deep enough to retain lubricant therein even after having debris cleared or wiped therefrom. A preferred embodiment employs an array of rows and columns of such nano-pockets having a depth no greater than 15 microns and preferably between 10-12 microns which can overlap one another and which form a hydrodynamic bearing from the lubricant film produced by high temperature high pressure lithium containing petroleum based grease retained in each pocket even after repeated debris cleanings or wiping occur during mold cycling. Such a mold interlock assembly can also have one or more reliefs formed in the head of the male lock and/or the receptacle of the female lock which are debris repositories in which debris self-cleaned from the head and receptacle sidewall surfaces during head insertion and/or removal from the receptacle and which can also serve as lubricant reservoirs which re-lubricate one of more of the head and/or receptacle sidewall surfaces during mold cycling.

The present invention is directed to an alignment lock assembly, preferably a mold lock or bar lock, for facilitating alignment of one component of a reciprocating machine relative to another component of the reciprocating machine during relative reciprocation thereof, the lock assembly that has a male lock half carried by one component, the male lock half comprised of an engagement surface, a female lock half carried by the another component, the female lock half comprised of an engagement surface opposed to the engagement surface of the male lock half during reciprocation of the one component relative to the another component, and wherein the engagement surface of at least one of the male and female lock halves is configured to reduce wear during reciprocation of the one component relative to the another component. At least one of the engagement surfaces is comprised of a three-dimensionally contoured lubricant film retaining region configured to retain a film of lubricant thereon, the three-dimensionally contoured lubricant film retaining region comprised of at least a plurality of pairs of lubricant-retaining recesses formed in the at least one of the engagement surfaces. Each lubricant-retaining recess has a depth no greater than 25 microns and configured to shed debris therefrom during contact between adjacent and opposed engagement surfaces of the male and female lock half during relative movement therebetween during reciprocation of the one component relative to the other component.

At least 40% of the surface area of the at least one of the engagement surfaces is comprised of the lubricant-retaining recesses as this ensures that a more uniform lubricant film is produced or formed thereon and that re-lubrication of lubricant from the lubricant-retaining recesses also is more uniform further helping to ensure that a more uniform lubricant film is produced. As a result, wear is reduced and preferably minimized through more uniform coverage and re-lubrication of lubricant along substantially the entire surface of the engagement surfaces of the male and female lock halves.

In one embodiment, each lubricant-retaining recess has a depth of no greater than 25 microns. Each lubricant-retaining recess has a sidewall and a bottom wall that is generally flat to facilitate debris shedding or removal during wiping action caused by the slidable contact between the engagement surfaces of the male and female lock halves. Each one of the lubricant-retaining recesses can be and preferably is in the form of a round, oval or oblong debris-shedding lubricant-retaining pocket. Each one of the lubricant-retaining recesses is comprised of a round, oval or oblong debris-shedding lubricant-retaining pocket. Each debris-shedding lubricant-retaining pocket preferably is laser etched or laser cut.

In an embodiment, each lubricant-retaining recess is formed of or by a recessed debris-shedding lubricant-retaining pocket formed in the at least one of the engagement surfaces having a depth no greater than about 25 microns. Each debris-shedding lubricant-retaining pocket has a sidewall bounding a generally flat bottom wall that preferably is a substantially flat bottom wall. In addition, at least 40% of the surface area of the at least one of the engagement surfaces is comprised of the debris-shedding lubricant-retaining pockets.

The engagement surface of at least one of the male and female lock halves is formed of at least a plurality of pairs of rows and at least a plurality of pairs of columns of uniformly spaced apart lubricant-retaining recesses, wherein the at least a plurality of pairs of rows of the lubricant-retaining recesses are uniformly spaced apart, and wherein the at least a plurality of pairs of columns of the lubricant-retaining recesses are uniformly spaced apart. At least 40% of the surface area of the engagement surface of at least one of the male and female lock halves is covered with the lubricant-retaining recesses. Each lubricant-retaining recess has a sidewall and a bottom wall that is substantially flat. Each lubricant-retaining recess has a depth of no greater than 25 microns. The substantially flat bottom wall of each lubricant-retaining recess preferably is disposed at a depth of no lower than 25 microns.

In at least one such embodiment, the lubricant-retaining recesses of each one of the rows are staggered relative to the lubricant-retaining recesses of each adjacent one of the rows, and the lubricant-retaining recesses of each one of the columns are staggered relative to the lubricant-retaining recesses of each adjacent one of the columns. Each one of the lubricant-retaining recesses of each one of the rows overlaps in a transverse direction relative to the one of the rows at least 25% of an adjacent one of the lubricant-retaining recesses of each adjacent one of the rows. Each lubricant-retaining recess has a depth of no greater than 25 microns. Each lubricant-retaining recess can be formed with a sidewall and a bottom wall that is generally flat. Each lubricant-retaining recess can be formed with a bottom wall that is substantially flat.

In one embodiment, each lubricant-retaining recess is a round, oval or oblong debris-shedding lubricant-retaining pocket recessed into the engagement surface of at least one of the male and female lock halves and which has a maximum depth no greater than about 25 microns. Each debris-shedding lubricant-retaining pocket has a bottom wall that is substantially flat and a sidewall substantially completely bounding the bottom wall. Each debris-shedding lubricant-retaining pocket can be and preferably is laser etched or laser cut.

In addition, at least one of the engagement surfaces can and preferably does have a debris repository well that is disposed adjacent the lubricant film retaining region that has a depth greater than the maximum depth of the lubricant-retaining recesses of the lubricant film retaining region. At least one of the engagement surfaces has a pair of debris repository wells that on opposite sides of the lubricant film retaining region, each debris repository well having a depth greater than the maximum depth of the lubricant-retaining recesses of the lubricant film retaining region. Each one of these debris repository wells also can and preferably does serve or function as a lubricant supply reservoir that gravity feeds lubricant wiped into the wells with debris back to the recesses or pockets of the lubricant-film retaining region of the engagement surface(s), including during re-lubrication during reciprocating machine cycling.

Each one of the lubricant-receiving recesses has a width or diameter of no more than about five millimeters, and a depth of no more than about 25 microns. Each one of the recesses is defined by a generally flat bottom wall having a depth of no more than about 25 microns. Each one of the recesses preferably is in the form of a generally round, circular, oval or oblong pocket formed by laser etching or laser cutting in the engagement surface of the male lock half and/or female lock half. Each one of the pockets has a bottom wall that preferably is generally flat and which is bounded by an upraised sidewall. In addition to being debris-shedding lubricant-retaining pockets, the pockets also provide a visual wear indicator, a bearing wear indicator, which visually shows a smooth surface lacking pockets when replacement due to wear is indicated

In a preferred embodiment, each one of the engagement surfaces of the male and female lock halves is comprised of a three-dimensionally contoured lubricant film retaining region formed of at least a plurality of pairs of spaced apart lubricant-retaining recesses formed therein having a maximum depth no greater than about 25 microns. The male lock half and female lock half preferably form one of a mold lock and bar lock.

The present invention also is directed to an alignment lock assembly, such as a mold lock or bar lock, for aligning or facilitating alignment of one component of a reciprocating machine, e.g., a molding machine, relative to another component of the reciprocating machine during relative reciprocation thereof, the lock assembly that includes a male lock half with an outwardly extending alignment head, and female lock half having a receptacle in which the alignment head of the male lock is removably received causing alignment of the male lock and female lock during receipt of the head of the male lock in the receptacle. The male lock half and female lock half each have at least one engagement surface that come into slidable moving contact with one another during reciprocating of one component, e.g., one mold half, of the reciprocating machine relative to another component, e.g., another mold half, of the reciprocating machine. The head of the male lock half is defined by a pair of spaced apart walls, at least one of which has an engagement surface. The receptacle of the female lock half is defined by a pair of spaced apart walls at least one of the walls having an engagement surface. At least one of the engagement surfaces is three-dimensionally contoured with at least a plurality of pairs of lubricant-retaining recesses, each of which is deep enough to hold lubricant but shallow enough to allow shedding of debris therefrom.

In one preferred embodiment, one of the head of the male lock half and the receptacle formed in the female lock half are defined by complementary engagement surfaces that contact one another during receipt of the head of the male lock half in the receptacle in the female lock half during alignment interlocking therewith or during removal of the male lock half from the receptacle in the female lock half during separation of the male lock half from the female lock half. At least one of the engagement surfaces of the one of the male lock half and female lock half has a bearing surface, in the form of a three-dimensionally contoured lubricant-retaining region, comprised of spaced apart hydrodynamic bearing layer forming lubricant-holding recesses formed therein that not only retain lubricant therein but which also form a hydrodynamic bearing layer along the bearing surface when lubricant is received in the lubricant-holding recesses.

Each one of the lubricant-receiving recesses is deep enough to hold a lubricant therein but shallow enough for debris accumulated therein to be removed therefrom by contact with the other one of the engagement surfaces of the other one of the male lock half and female lock half during one of insertion of the head of the male lock half into the receptacle in the female lock half and removal of the head of the male lock half from the receptacle in the female lock half. Contact between the engagement surfaces of the one of the male lock half and female lock half during insertion of the head of the male lock half into the receptacle in the female lock half is slidable wiping contact that self-cleans debris accumulated in the lubricant-receiving recesses during insertion of the head of the male lock half into the receptacle in the female lock half. The contact between the engagement surfaces of the one of the male lock half and female lock half during removal of the head of the male lock half from the receptacle in the female lock half is slidable wiping contact that self-cleans debris accumulated in the lubricant-receiving recesses during removal of the head of the male lock half from the receptacle in the female lock half.

Each one of the lubricant-receiving recesses has a width or diameter of no more than about five millimeters, and a depth of no more than about 25 microns. Each one of the recesses is defined by a generally flat bottom wall having a depth of no more than about 25 microns. Each one of the recesses preferably is in the form of a generally round, circular, oval or oblong pocket formed by laser etching or laser cutting in the engagement surface of the male lock half and/or female lock half. Each one of the pockets has a bottom wall that preferably is generally flat and which is bounded by an upraised sidewall. In addition to being debris-shedding lubricant-retaining pockets, the pockets also provide a visual wear indicator, a bearing wear indicator, which visually shows a smooth surface lacking pockets when replacement due to wear is indicated.

The head of the male lock has a three-dimensionally contoured profile that not only facilitates insertion of the head into the receptacle in the female lock, but which also has a debris catcher in which debris wiped from the lubricant-dispensing packets accumulates. The profile of the head of the male lock is configured to make wiping contact during one of insertion of the head of the male lock into the receptacle in the female lock and removal of the head of the male lock from the receptacle in the female lock. The head has a generally rectangular cross-section with an outwardly extending grease-spreading and debris-clearing wiping surface at or adjacent a free end of the head and a necked down relief that serves a debris collecting relief formed in the head of the male lock. The receptacle formed in the female lock half is defined by a pair of generally parallel generally planar sidewalls extending oppositely and toward one another from an open mouth at one end of the receptacle to an endwall at an opposite end of the receptacle, and wherein the open end has an inwardly tapering lead in profile contour that defines a cross-section width of the receptacle at the mouth that is greater than a cross-sectional width of the receptacle downstream of the mouth facilitating misaligned entry of the head of the male lock into the receptacle. Contact between the engagement regions of the one of the male lock half and female lock half during removal of the head of the male lock half from the receptacle in the female lock half is slidable wiping contact that self-cleans debris accumulated in the lubricant-receiving recesses during removal of the head of the male lock half from the receptacle in the female lock half.

Understandably, the present invention has been described above in terms of one or more preferred embodiments and methods. It is recognized that various alternatives and modifications may be made to these embodiments and methods that are within the scope of the present invention. It is also to be understood that, although the foregoing description and drawings describe and illustrate in detail one or more preferred embodiments of the present invention, to those skilled in the art to which the present invention relates, the present disclosure will suggest many modifications and constructions as well as widely differing embodiments and applications without thereby departing from the spirit and scope of the invention. The present invention, therefore, is intended to be limited only by the scope of the appended claims.

1. An alignment lock assembly for facilitating alignment of one component of a reciprocating machine relative to another component of the reciprocating machine during relative reciprocation thereof, the lock assembly comprising:
(a) a male lock half carried by one component, the male lock half comprised of an engagement surface; and
(b) a female lock half carried by the another component, the female lock half comprised of an engagement surface opposed to the engagement surface of the male lock half during reciprocation of the one component relative to the another component; and
wherein the engagement surface of at least one of the male and female lock halves is configured to reduce wear during reciprocation of the one component relative to the another component.

2. The lock assembly of claim 1, wherein the at least one of the engagement surfaces is comprised of a three-dimensionally contoured lubricant film retaining region configured to retain a film of lubricant thereon, the three-dimensionally contoured lubricant film retaining region comprised of at least a plurality of pairs of lubricant-retaining recesses formed in the at least one of the engagement surfaces.

3. The lock assembly of claim 2, wherein each lubricant-retaining recess has a depth no greater than 25 microns and configured to shed debris therefrom during contact between adjacent and opposed engagement surfaces of the male and female lock half during relative movement therebetween during reciprocation of the one component relative to the another component.

4. The lock assembly of claim 2, wherein each lubricant-retaining recess has a depth of no greater than 25 microns.

5. The lock assembly of claim 4, wherein each lubricant-retaining recess has a sidewall and a bottom wall that is generally flat.

6. The lock assembly of claim 3, wherein each one of the lubricant-retaining recesses is comprised of a round, oval or oblong debris-shedding lubricant-retaining pocket.

7. The lock assembly of claim 6, wherein each debris-shedding lubricant-retaining pocket has a sidewall bounding a generally flat bottom wall.

8. The lock assembly of claim 7, wherein each debris-shedding lubricant-retaining pocket is laser etched or laser cut.

9. The lock assembly of claim 2, wherein at least 40% of the surface area of the at least one of the engagement surfaces is comprised of the lubricant-retaining recesses.

10. The lock assembly of claim 2, wherein each lubricant-retaining recess is comprised of a recessed debris-shedding lubricant-retaining pocket formed in the at least one of the engagement surfaces having a depth no greater than about 25 microns.

11. The lock assembly of claim 10, wherein each debris-shedding lubricant-retaining pocket has a sidewall bounding a generally flat bottom wall.

12. The lock assembly of claim 10, wherein at least 40% of the surface area of the at least one of the engagement surfaces is comprised of the debris-shedding lubricant-retaining pockets.

13. The lock assembly of claim 1, wherein the engagement surface of at least one of the male and female lock halves is comprised of at least a plurality of pairs of rows and at least a plurality of pairs of columns of uniformly spaced apart lubricant-retaining recesses, wherein the at least a plurality of pairs of rows of the lubricant-retaining recesses are uniformly spaced apart, and wherein the at least a plurality of pairs of columns of the lubricant-retaining recesses are uniformly spaced apart.

14. The lock assembly of claim 13, wherein at least 40% of the surface area of the engagement surface of at least one of the male and female lock halves is covered with the lubricant-retaining recesses.

15. The lock assembly of claim 14, wherein each lubricant-retaining recess has a sidewall and a bottom wall that is substantially flat.

16. The lock assembly of claim 14, wherein each lubricant-retaining recess has a depth of no greater than 25 microns.

17. The lock assembly of claim 13, wherein the lubricant-retaining recesses of each one of the rows is staggered relative to the lubricant-retaining recesses of each adjacent one of the rows, and the lubricant-retaining recesses of each one of the columns is staggered relative to the lubricant-retaining recesses of each adjacent one of the columns.

18. The lock assembly of claim 17, wherein each one of the lubricant-retaining recesses of each one of the rows overlaps in a transverse direction relative to the one of the rows at least 25% of an adjacent one of the lubricant-retaining recesses of each adjacent one of the rows.

19. The lock assembly of claim 18, wherein each lubricant-retaining recess has a depth of no greater than 25 microns.

20. The lock assembly of claim 18, wherein each lubricant-retaining recess has a sidewall and a bottom wall that is substantially flat.

21. The lock assembly of claim 18, wherein each lubricant-retaining recess is a round, oval or oblong debris-shedding lubricant-retaining pocket recessed into the engagement surface of at least one of the male and female lock halves and which has a maximum depth no greater than about 25 microns.

22. The lock assembly of claim 21, wherein the debris-shedding lubricant-retaining pockets define a wear indicator.

23. The lock assembly of claim 18, wherein each debris-shedding lubricant-retaining pocket has a bottom wall that is substantially flat and a sidewall substantially completely bounding the bottom wall.

24. The lock assembly of claim 23, wherein each debris-shedding lubricant-retaining pocket is laser etched or laser cut.

25. The lock assembly of claim 2, wherein the at least one of the engagement surfaces has a debris repository well that is disposed adjacent the lubricant film retaining region that has a depth greater than the maximum depth of the lubricant-retaining recesses of the lubricant film retaining region.

26. The lock assembly of claim 2, wherein the at least one of the engagement surfaces has a pair of debris repository wells that on opposite sides of the lubricant film retaining region, each debris repository well having a depth greater than the maximum depth of the lubricant-retaining recesses of the lubricant film retaining region.

27. The lock assembly of claim 1, wherein each one of the engagement surfaces of the male and female lock halves is comprised of a three-dimensionally contoured lubricant film retaining region formed of at least a plurality of pairs of spaced apart lubricant-retaining recesses formed therein having a maximum depth no greater than about 25 microns.

28. The lock assembly of claim 1, wherein the male lock half and female lock half form one of a mold lock and bar lock.
